(19) United States
(12) Patent Application Publication
(10) Pub. No.: US 2015/0206057 A1
(43) Pub. Date: Jul. 23, 2015

(54) NON-TRANSITORY COMPUTER READABLE MEDIUM AND STATE ESTIMATION APPARATUS

(71) Applicant: FUJI XEROX CO., LTD., Tokyo (JP)

(72) Inventor: Masahiro SATO, Yokohama-shi (JP)

(73) Assignee: FUJI XEROX CO., LTD., Tokyo (JP)

(21) Appl. No.: 14/670,479

(22) Filed: Mar. 27, 2015

Related U.S. Application Data
(63) Continuation of application No. PCT/JP2013/069125, filed on Jul. 12, 2013.

(30) Foreign Application Priority Data
Nov. 2, 2012 (JP) 2012-242493

(51) Int. Cl. G06N 5/04; G06N 7/00

(52) U.S. Cl. CPC G06N 5/047; G06N 7/005

(57) ABSTRACT

A state estimation apparatus includes: a first state estimation section that estimates a plurality of states of a user carrying a sensor on the basis of information obtained by the sensor; a detection section that detects a predefined pattern on the basis of the information obtained by the sensor; a selection section that selects different ones of a plurality of transition probabilities depending upon whether or not the pattern is detected by the detection section, the transition probabilities each being registered as a probability of a transition between individual states among the plural states.

### CROSS REFERENCE TO RELATED APPLICATION

This is a continuation of International Application No. PCT/JP2013/069125 filed on Jul. 12, 2013, and claims priority from Japanese Patent Application No. 2012-242493, filed on Nov. 2, 2012.

### BACKGROUND

1. Technical Field

The present invention relates to a non-transitory computer readable medium and a state estimation apparatus.

2. Related Art

A state estimation apparatus which predicts a user's operation on the basis of a detected change in conditions has been proposed as one of the ordinary arts.

### SUMMARY

An aspect of the present invention provides a non-transitory computer readable medium storing a program causing a computer to function as a first state estimation section that estimates a state of a user carrying a sensor on the basis of information obtained by the sensor, a detection section that detects a predefined pattern on the basis of the information obtained by the sensor, a selection section that selects different ones of a plurality of transition probabilities depending upon whether or not the pattern is detected by the detection section, the transition probabilities each being registered as a probability of a transition between individual states among the plural states.

### BRIEF DESCRIPTION OF THE DRAWINGS

Exemplary embodiment(s) of the present invention will be described in detail based on the following figures, wherein:

FIG. 1 is a block diagram which illustrates an example configuration of a state estimation apparatus;

FIGS. 2A and 2B are graphs which illustrate example configurations of pattern information;

FIGS. 3A to 3D are graphs which illustrate example configurations of transition probability information;

FIG. 4 is an outline diagram describing relationships between primary states and secondary states, and relationships with pattern information during transitions to and from individual states;

FIG. 5 is another outline diagram describing relationships between primary states and secondary states, and relationships with pattern information during transitions to and from individual states;

FIGS. 6A and 6B are graphs which illustrate an example temporal change in acceleration detected by a sensor, which is to be detected by pattern detection section;

FIG. 7A is an outline diagram describing operations for estimating primary and secondary states upon a pattern being detected. Further, FIG. 7B is an outline diagram describing ordinary operations for estimating primary and secondary states when no pattern is detected; and

FIG. 8 is a flowchart which illustrates an example operation of the state estimation apparatus.

### DETAILED DESCRIPTION

### Embodiment

### Configuration of State Estimation Apparatus

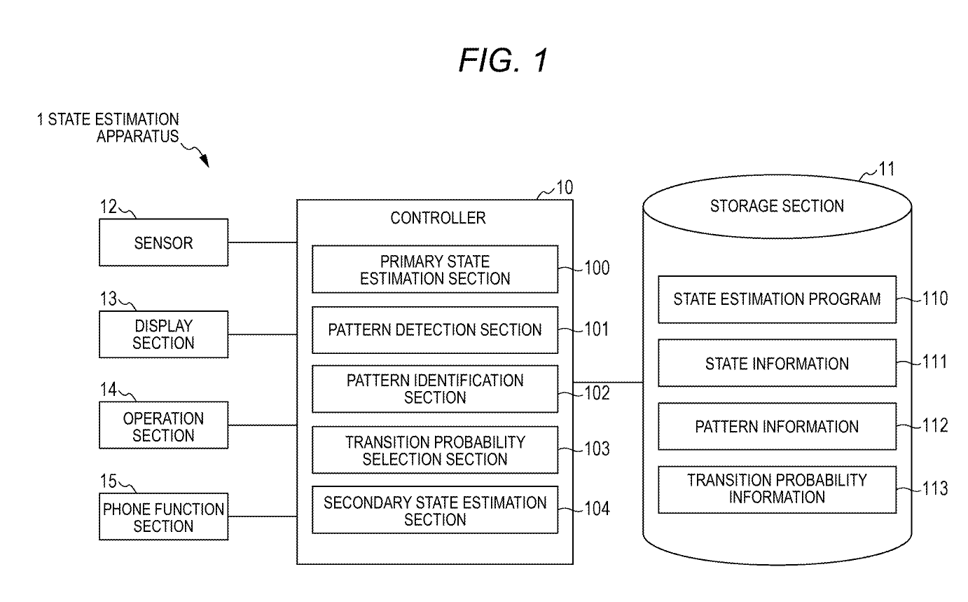

FIG. 1 is a block diagram which illustrates an example configuration of a state estimation apparatus 1.

The state estimation apparatus 1 is, e.g., a mobile phone, etc., and has a controller 10 formed of a CPU, etc., which controls respective portions and runs various kinds of programs, a storage section 11, i.e., an example storage apparatus formed of a storage medium such as an HDD (Hard Disk Drive), a flash memory, etc., which stores information, a sensor 12, i.e., an accelerometer, etc., which detects acceleration in three-axis directions, a display section 13 which displays a character, an image, etc., an operation section 14 such as a push-button switch, a touch sensor, etc., and a phone function section 15 including a microphone, a speaker, etc.

The controller 10 functions as a primary state estimation section 100, a pattern detection section 101, a pattern identification section 102, a transition probability selection section 103, a secondary state estimation section 104, etc., by running a state estimation program 110 described later.

The primary state estimation section 100 estimates a primary state which is estimated directly on the basis of information on acceleration, etc., detected by the sensor 12 (called “sensor information”, hereafter). The primary state mentioned here is a state such that a user using the state estimation apparatus 1 is on a phone, i.e., “utterance state”, that the user is reading the display section 13, i.e., “reading state”, that the user is staying still without doing anything, i.e., “standstill state” and so on, and the primary state is registered in state information 111 in advance in association with the acceleration. Further, the primary state is not limited to the acceleration detected by the sensor 12, and may be estimated on the basis of a display state on the display section 13 or on the basis of states of using the operation section 14 and the phone function section 15.

Further, the secondary state to which the primary state belongs will be explained here. In conditions such as “in-house meeting”, e.g., the secondary state is such that a user using the state estimation apparatus 1 is in a meeting, i.e., “meeting state”, that the user is on standby without attending a meeting, i.e., “standby state” and so on, and the secondary state is indirectly estimated on the basis of the acceleration, etc., detected by the sensor 12. The secondary state is registered in the state information 111 in advance as well.

The pattern detection section 101 detects a pattern of a temporal change in the sensor information such as the acceleration detected by the sensor 12. The pattern mentioned here is detected on the basis of a temporal change in sensor information which appears in a shorter time range than a time range of sensor information to be estimated by the primary state estimation section 100 for the primary state.

Incidentally, the primary state estimation section 100 and the pattern detection section 110 estimate a primary state and detect a pattern, respectively, by detecting a characteristic quantity such as a peak frequency, etc., calculated from the sensor information, a steep value change and a value not less than a threshold, degradation of regularity or periodicity, a specific shape of a waveform, and so on.

The pattern identification section 102 identifies which of predefined pattern information 112 a pattern detected by the pattern detection section 101 resembles.

The transition probability selection section 103 selects, on the basis of the pattern identified by the pattern identification section 102, a corresponding probability out of transition probability information 113 which is transition probabilities to and from the secondary states. Incidentally, unless the pattern identification section 102 can identify a pattern, it is acceptable to give a transition probability of a pattern that comparatively resembles the pattern a weighting based on a degree of resemblance so as to calculate the transition probability.

The secondary state estimation section 104 estimates secondary states before and after the pattern detection section 101 detects a pattern on the basis of the transition probability selected by the transition probability selection section 103.

The storage section 11 contains the state estimation program 110, the state information 111, the pattern information 112, the transition probability information 113 and so on.

The state estimation program 110 is a program that causes the controller 10 to function as the respective sections 100 to 104 described above by being run by the controller 10.

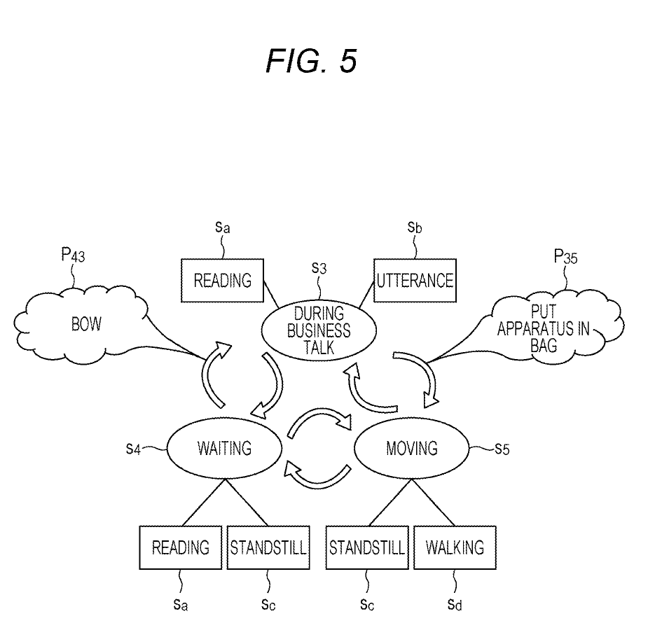

The state information 111 is information registered in advance, and includes a plurality of primary states and secondary states associated with the primary states as illustrated in FIGS. 4 and 5 described later.

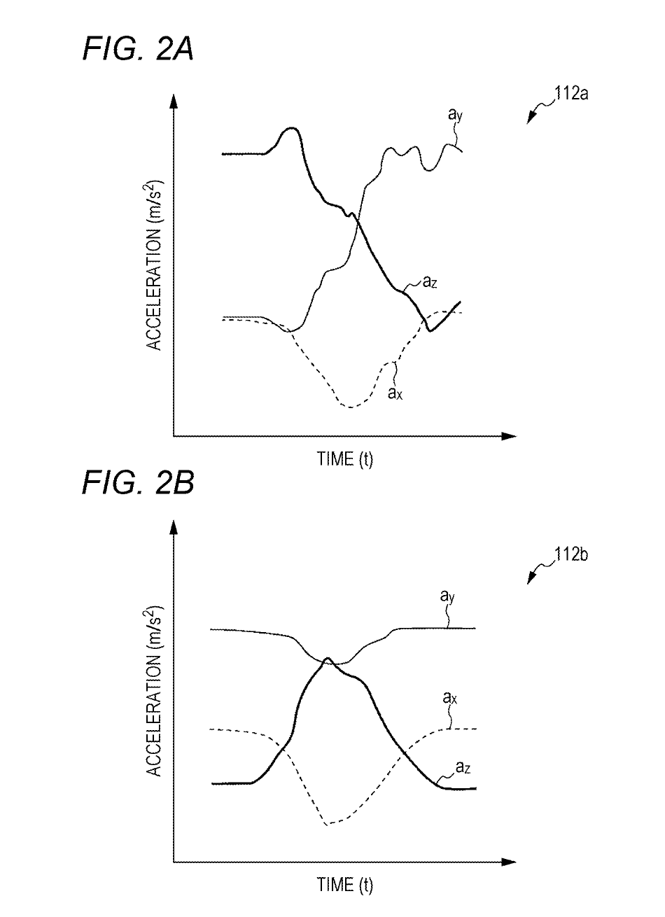

The pattern information 112 includes a plurality of patterns of temporal changes in acceleration as illustrated in FIGS. 2A and 2B described later.

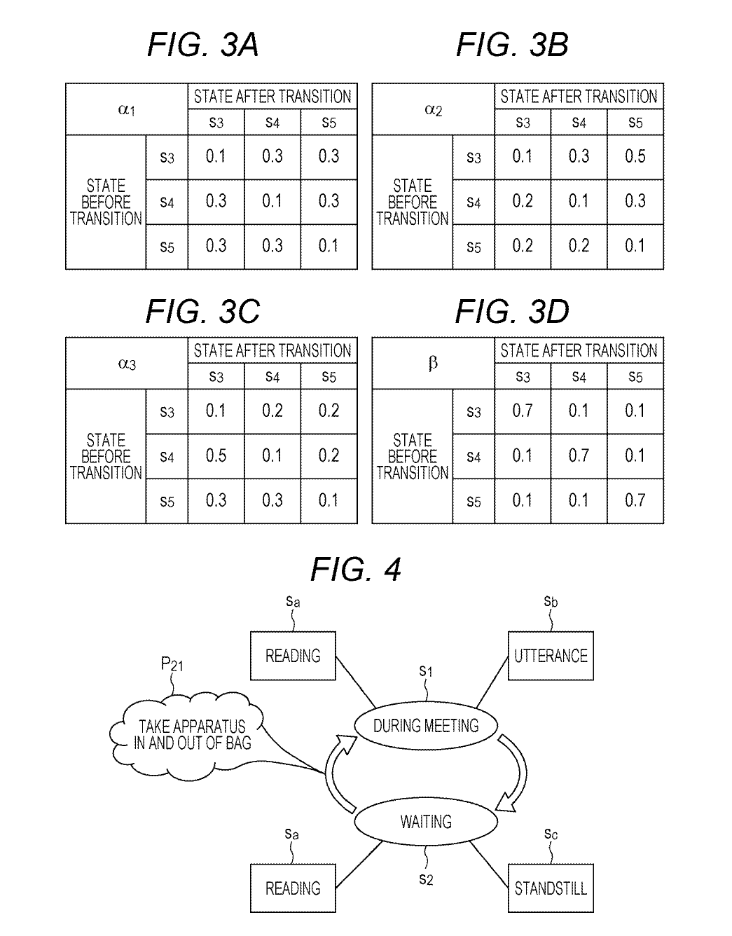

The transition probability information 113 includes a plurality of transition probabilities individually associated with each of the patterns in the pattern information 112 as illustrated in FIGS. 3A to 3D described later.

Incidentally, the state estimation apparatus 1 is a mobile phone or the like, or a portable data processing terminal equipped with the sensor 12, and may be configured by using a server apparatus or a personal computer, with the sensor 12 separately used.

Further, it is acceptable to use as the sensor 12 an illuminance sensor, a proximity sensor, etc., in addition to the acceleration sensor, and to detect a nearby user by using Bluetooth (registered trademark), etc. Further, it is acceptable to collect surrounding sonic reflections by using a microphone so as to estimate from audio information a primary state of a user, or to identify voice included in the voice information so as to detect the presence of a nearby user.

FIGS. 2A and 2B are graphs which illustrate an example configuration of the pattern information 112.

As illustrated in FIG. 2A, a pattern 112a of temporal changes in acceleration values in three-axis directions detected by the sensor 12 is registered in advance in the pattern information 112 as an “action of taking the state estimation apparatus 1 in a bag”. Incidentally, terms aₓ, a_{y}, and a_{z} are acceleration values in x-, y-, and z-directions, respectively. Further, if the state estimation apparatus 1 is a mobile phone, etc., the x-, y-, and z-directions are horizontal, vertical, and normal directions of the display section 13, respectively.

As illustrated in FIG. 2B, further, a pattern 112b of temporal changes in the acceleration values in the three-axis directions detected by the sensor 12 is registered in advance in the pattern information 112 as an “action of bowing performed by a user having placed the state estimation apparatus 1 in a chest pocket”.

FIGS. 3A to 3D are graphs which illustrate an example configuration of the transition probability information 113.

Transition probabilities α₁ through α₃ are transition probabilities selected by the transition probability selection section 103 when the pattern detection section 101 detects a pattern. Which one of the transition probabilities α₁ through α₃ is selected depends upon the pattern identified by the pattern identification section 102.

Further, a transition probability β illustrated in FIG. 3D is a transition probability selected by the transition probability selection section 103 when the pattern detection section 101 detects no pattern.

FIG. 4 is an outline diagram describing relationships between the primary states and the secondary states, and a relationship with the pattern information during a transition to and from the individual states.

In the condition “in-house meeting” included in the state information 111, a primary state sₐ belongs to secondary states s₁ and s₂, a primary state s_{b} belongs to the secondary state s_{1,} and a primary state s_{c} belongs to the secondary state s₂. Further, while a transition from the secondary state s₁ to the state s₂ occurs with a predefined transition probability, a transition from the secondary state s₂to the state s₁ occurs with different probabilities depending upon whether or not a pattern P₂₁ is detected.

The primary state sₐ “reading” mentioned here indicates a state in which the user is reading a web page on the display section 13 by using an Internet browsing function provided to the state estimation apparatus 1. Further, the state s_{b} “utterance” indicates a state in which the user is talking by using the phone function section 15 of the state estimation apparatus 1. Further, the state s_{c} “standstill” indicates a state in which the user is doing nothing.

FIG. 5 is another outline diagram describing relationships between the primary states and the secondary states, and relationships with the pattern information during transitions to and from the individual states.

In the condition “on business” included in the state information 111, the primary state sₐ belongs to secondary states s₃ and s₄, the primary state s_{b} belongs to the secondary state s₃, the primary state s_{c} belongs to secondary states s₄ and s₅, and a primary state s_{d} belongs to the secondary state s₅. Further, while transitions from the secondary state s₃ to the state s₄, between the secondary states s₄ and s₅ and from the secondary state s₅ to the state s₃ each occur with a predefined transition probability, transitions from the secondary state s₃ to the state s₅ and from the secondary state s₄ to the state s₃ each occur with different probabilities depending upon whether or not patterns P₃₅ and P₄₃ are detected.

The primary state s_{d} “walking” mentioned here indicates a state in which the user is walking while holding the state estimation apparatus 1.

### Operations of State Estimation Apparatus

Next, operations of the embodiment are divided into (1) fundamental operations, (2) primary state estimation operations, and (3) secondary state estimation operations, each of which will be explained.

### (1) Fundamental Operations

At first, a user carries the state estimation apparatus 1 and conducts various activities. Example activities are activities such as the user moving or bowing after having placed the state estimation apparatus 1 in a chest pocket of a shirt that the user is wearing, moves or bows, the user carrying the state estimation apparatus 1 in a bag owned by the user, etc., the user reading web pages on the display section 13 by using an Internet browsing function provided to the state estimation apparatus 1, or the user talking while using the phone function section 15 of the state estimation apparatus 1.

### (2) Primary State Estimation Operations

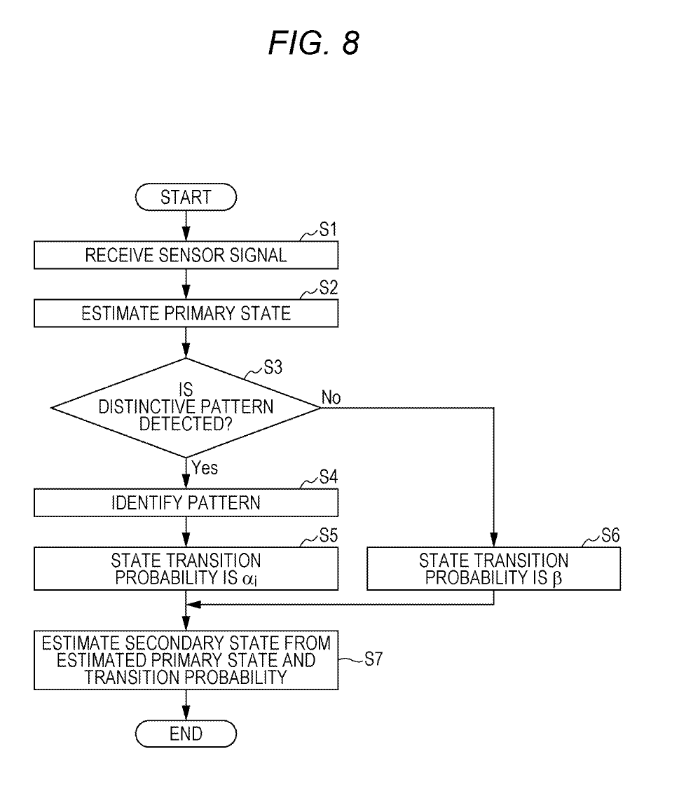

FIG. 8 is a flowchart which illustrates an example operation of the state estimation apparatus 1.

The primary state estimation section 100 of the state estimation apparatus 1 receives acceleration detected by the sensor 12 in accordance with the user's activities described above (S1), and estimates the state that the user is in. That is, the primary state estimation section estimates a primary state (S2). Further, the primary state estimation section 100 may estimate a state not only on the basis of the acceleration detected by the sensor 12, but also on the basis of a display state on the display section 13 or on the basis of the states of use of the operation section 14 and the phone function section 15.

The primary state estimated by the primary state estimation section 100 mentioned here is one of the primary states sₐ “reading”, s_{b} “utterance”, s_{c} “standstill”, or s_{d} “walking”, etc., illustrated in FIGS. 4 and 5.

### (3) Secondary State Estimation Operations

Next, the pattern detection section 101 detects a pattern of a temporal change in the acceleration detected by the sensor 12 (S3).

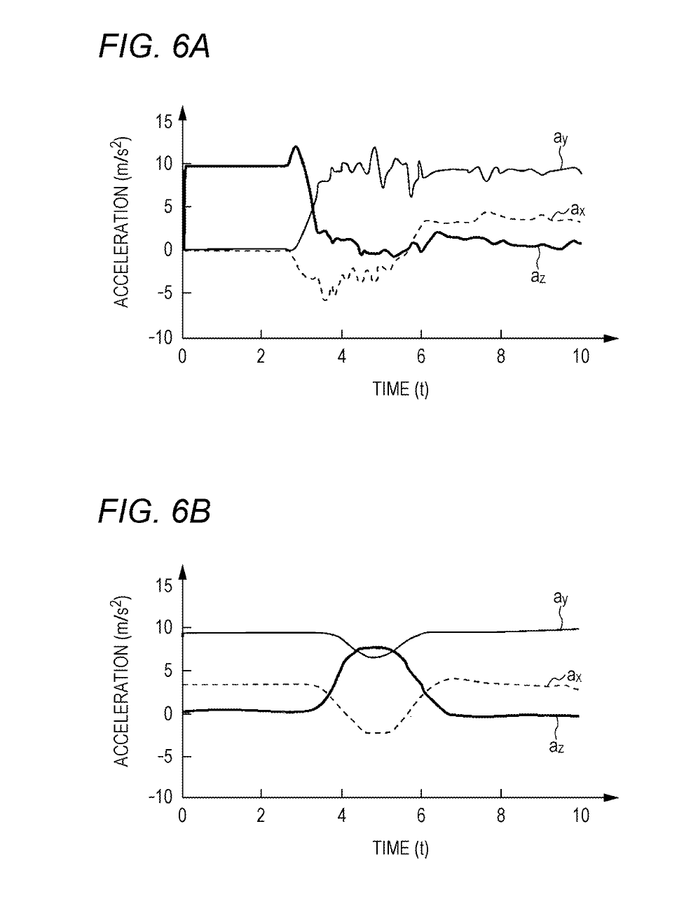

FIGS. 6A and 6B are graphs which illustrate an example temporal change in the acceleration detected by the sensor 12, the example temporal change in acceleration to be detected by the pattern detection section 101.

The pattern detection section 101 detects as a pattern distinctive temporal changes which temporarily occur on the acceleration values aₓ, a_{y} and a_{z} illustrated in FIGS. 6A and 6B (S3; Yes), detects temporal changes as a pattern while t=2 to 5 for the example illustrated in FIG. 6A, and detects temporal changes as a pattern while t=3 to 7 for the example illustrated in FIG. 6B.

Then, the pattern identification section 102 identifies which of the predefined pattern information 112 the pattern detected by the pattern detection section 101 resembles (S4).

For instance, the pattern while t=2 to 5 extracted from FIG. 6A is identified as the pattern 112a illustrated in FIG. 2A. Incidentally, an example method for identifying a pattern is to calculate a DTW (Dynamic Time Warping) distance, and to determine resemblance to the pattern registered in the pattern information 112 upon the calculated DTW distance being smaller than a preset threshold.

Further, the pattern while t=3 to 7 extracted from FIG. 6B is identified as the pattern 112b illustrated in FIG. 2B.

Then, the transition probability selection section 103 selects, on the basis of the pattern 112a or 112b identified by the pattern identification section 102, the corresponding transition probability α₁ or α₂ which is a probability of a transition to and from the secondary states out of the transition probability information 113 (S5).

Further, if the pattern detection section 101 detects no pattern at the step S3 (S3; No), the transition probability selection section 103 selects the transition probability β as the transition probability in a case of no detected pattern (S6).

The secondary state estimation section 104 estimates a secondary state before and after the pattern detection section 101 detects a pattern on the basis of the transition probability selected by the transition probability selection section 103 (S7).

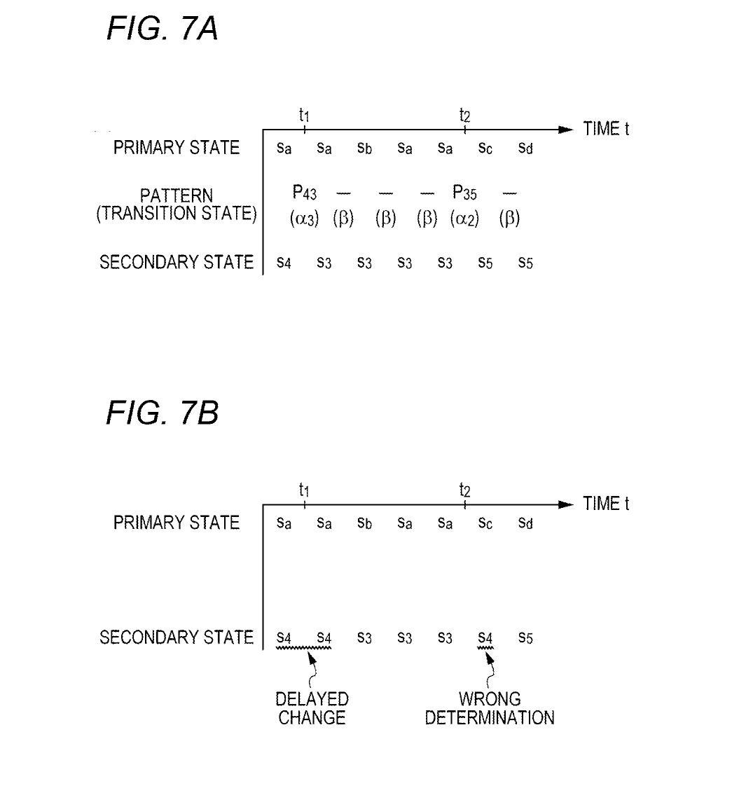

The operation described above is, if specifically explained, as illustrated in FIG. 7A.

FIG. 7A is an outline diagram describing the operations to estimate the primary and secondary states when a pattern is detected. Further, FIG. 7B is an outline diagram describing ordinary operations for estimating the primary and secondary states in a case of no detected pattern.

If the pattern identification section 102 identifies detection of the pattern P₄₃ at time t₁ as illustrated in FIG. 7A, the transition probability selection section 103 selects the transition probability α₃. As a result, since the transition probability from the secondary state s₄ to the state s₃ is high, the secondary state estimation section 104 resultantly estimates that the secondary state has shifted from s₄ to s₃ at the time t₁.

Further, if the pattern identification section 102 similarly identifies detection of the pattern P₃₅ at time t₂, the transition probability selection section 103 selects the transition probability α₂. As a result, since the transition probability from the secondary state s₃ to the state s₅ is high, the secondary state estimation section 104 resultantly estimates that the secondary state has shifted from s₃ to s₅ at the time t₂.

Incidentally, as no pattern is detected at any time except t₁ and t₂, the transition probability selection section 103 selects the transition probability β. Since the probability of transition from the current secondary state to another secondary state is low, the chance of a wrong determination being made is reduced.

On the other hand, as the primary state sₐ is present in both of the secondary states s₃ and s₄ as illustrated in FIG. 7B and the transition probability between the secondary states s₃ and s₄ is constant in a case of no detected pattern, a possibility increases that the change in the secondary state caused at the time t₁ cannot be estimated, resulting in a delayed change. Further, as the primary state s_{c} is present in both of the secondary states s₄ and s₅, a possibility increases that a transition to s₄ at the time t₂ is erroneously determined.

### Effect of the Embodiment

The embodiment described above is to detect a pattern on the basis of the sensor information separately from the operation to estimate the primary state from the sensor information and to change the transition probability in accordance with the detected pattern, so that wrong determinations of the state transitions can be reduced compared to a case where no pattern detection is conducted.

### Other Embodiments

Incidentally, the invention is not limited to the embodiment described above, and can be modified variously within the scope of the invention. For example, in a case where the pattern identification section 102, which has detected plural kinds of patterns, cannot determine which one is relevant, the transition probability selection section 103 may give the transition probabilities weightings on the basis of a probability corresponding to each of the patterns and figure out the sum, so as to calculate a new transition probability.

Further, if the pattern detection section 101 detects the same pattern plural times in a certain period of time, e.g., the pattern detection section detects the activity of bowing plural times for greeting people, etc., the transition probability selection section 103 may unify the plural detections and select a transition probability just once.

Further, although the primary state estimated on the basis of the sensor information and the secondary state estimated on the basis of the primary state are explained, it is acceptable to estimate even higher (tertiary, quaternary, and so forth) states estimated on the basis of the secondary state and to apply the invention to the probability of transitions to and from the higher states.

Although the functions of the respective section 100 to 109 in the controller 10 of the embodiment described above are each implemented by a program, the respective section may be entirely or partially implemented by hardware such as an ASIC, etc. Further, the program used in the embodiment described above can be provided, with it stored on a recording medium such as a CD-ROM. Further, the steps described above explained in the embodiment described above can be exchanged, cancelled, added, etc., without a change in the gist of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to function as:
a first state estimation section that estimates a plurality of states of a user carrying a sensor on the basis of information obtained by the sensor;
a detection section that detects a predefined pattern on the basis of the information obtained by the sensor; and
a selection section that selects different ones of a plurality of transition probabilities depending upon whether or not the pattern is detected by the detection section, the transition probabilities each being registered as a probability of a transition between individual states among the plural states.

2. The non-transitory computer readable medium according to claim 1, wherein the selection section selects a different one of the transition probabilities in accordance with a kind of the pattern detected by the detection section.

3. The non-transitory computer readable medium according to claim 1, wherein the computer is caused to further function as a second state estimation section that estimates a history of a change in the states before and after the detection section detects a pattern based on the transition probability selected by the selection section.

4. The non-transitory computer readable medium according to claim 1, wherein the state estimated by the first state estimation section is a primary state, and
the computer is caused to further function as second state estimation section that estimates a history of a change in a secondary state to which the primary state belongs before and after the detection section detects a pattern on the basis of the transition probability selected by the selection section.

5. The non-transitory computer readable medium according to claim 1, wherein the transition probabilities are set in such a way that a probability of a transition to another state set in response to the detection section detecting the pattern is higher than a probability of the transition to another state set in response to the detection section not detecting the pattern.

6. The non-transitory computer readable medium according to claim 1, wherein when the detection section detects the predefined pattern a plurality of times in a certain period of time, the selection section selects one transition probability for the detection of the plural times.

7. The non-transitory computer readable medium according to claim 1, wherein when the detection section is unable to determine which one of a plurality of kinds of predefined patterns each being the predefined pattern having been detected is relevant, the selection section sums a plurality of transition probabilities corresponding to the plural kinds of predefined patterns by weighting on the basis of a plurality of individually corresponding probabilities so as to provide a new transition probability.

8. A state estimation apparatus comprising:
a first state estimation section that estimates a plurality of states of a user carrying a sensor on the basis of information obtained by the sensor;
a detection section that detects a predefined pattern on the basis of the information obtained by the sensor; and
a selection section that selects different ones of a plurality of transition probabilities depending upon whether or not the pattern is detected by the detection section, the transition probabilities each being registered as a probability of a transition between individual states among the plural states.
